(19) United States
(12) Patent Application Publication
(10) Pub. No.: US 2026/0336501 A1
(43) Pub. Date: Oct. 29, 2026

(54) MOBILE ARCADE BASKETBALL TRAILER SYSTEM AND METHOD OF USE

(71) Applicant: Scott R. Mosteller, San Diego, CA (US)

(72) Inventor: Scott R. Mosteller, San Diego, CA (US)

(21) Appl. No.: 19/719,035

(22) Filed: Jun. 24, 2026

Related U.S. Application Data
(63) Continuation of application No. 19/375,152, filed on Oct. 30, 2025.
(60) Provisional application No. 63/789,927, filed on Apr. 16, 2025.

(51) Int. Cl. B60P 3/025; A63F 7/06; B60J 3/00; B60J 5/04; B62D 63/08; B62D 65/02

(52) U.S. Cl. CPC B60P 3/025; B60J 3/002; B60J 5/0473; B62D 63/08; B62D 65/02; A63F 7/0612

(57) ABSTRACT

A mobile arcade game system includes a plurality of electronic arcade games within a mobile platform. The mobile platform can have dual-purpose, selectively-openable panels that can open to reveal the arcade games through opening in the sidewall while also forming a sun shade above players standing outside of the mobile arcade game system. The mobile platform can include a chamber under the arcade games that can provide strength and structural stability to the trailer despite the trailer having most of the sidewall replaced by an opening. Players can stand outside of the mobile arcade game system and can play fixed, indoor-style arcade games outdoors in the shade.

### RELATED APPLICATIONS

This application is a continuation of U.S. patent application Ser. No. 19/375,152, filed Oct. 30, 2025, entitled MOBILE ARCADE BASKETBALL TRAILER SYSTEM AND METHOD OF USE, which claims the benefit of U.S. Provisional Application Ser. No. 63/789,927, filed Apr. 16, 2025, entitled MOBILE ARCADE BASKETBALL TRAILER SYSTEM, the entire disclosure of which is herein incorporated by reference.

### FIELD OF THE INVENTION

This application relates to the field of arcade games, and particularly to the field of mobile arcade games.

### BACKGROUND OF THE INVENTION

Arcade games have been a pastime for many years. However, traditional arcade games are heavy and are kept in a fixed location, where they remain immobile and plugged in to a power source. Some arcade games, such as arcade basketball, require a significant amount of floor space in the fixed location, as well as a significant amount of headspace above the game. In arcade basketball, a player must accurately throw a ball through a small basketball-style goal that is located some distance from the player. The goal is typically an opening through a horizontal plane, approximately parallel with the ground. The goal is typically far enough away to require the player to aim and throw the ball with skill, and the goal is typically high enough to require the player to throw the ball upwards so that it comes back down under the force of gravity and falls through the goal. In order for game play to be fun and interesting, the goal, which is typically a hoop, must be high enough and far enough away to be challenging. The user then throws the ball forwards and upwards in an arced path in an attempt to get the ball to come down and fall into the goal that is some distance in front of the player.

Arcade basketball requires a significant amount of headspace and floorspace around the fixed location where it is placed. Balls must be able to travel upwards into the space above the game area so that they can arc back down and fall through the goal, even when the goal is positioned higher than the user's head. Furthermore, some users prefer to be able to step back and forth, simulating an active, sporting motion as they step forward towards the goal when they throw the ball, then pick up the next ball, then step backwards and prepare to take the next shot, which can include another forward stepping motion. The need for a large floorspace can be compounded by the timed nature of the game. The user has a fixed period of time to throw as many balls through the goal as possible. It should be clear that the active, sporting motions required, compounded by the sometimes frantic hurrying to throw as many balls through the goal as possible in the given time period, require that the player has ample room around, and particularly behind, the user so that the user can move quickly and freely without diverting the player's attention to the surrounding area during game play.

Unfortunately, given the large size of the arcade game itself, along with the requirements for space above, around, and behind the game, arcade basketball is often difficult to have inside of many facilities. However, for similar reasons, including the size and weight of the game, and requirements for a reliable source of electricity, the game has not been portable, and cannot be played outside where open space is more readily available. It would be desirable to have a way to adapt arcade basketball to be played outdoors in open areas. It would be further desirable to be able to quickly and easily transport a mobile arcade basketball game to be played in various locations, including parties and events. It would also be further desirable if the system could be equipped with an overhead cover to keep the sun out of the eyes of the player, with the cover being high enough and sufficiently out of the way so that it does not interfere with game play or the arcing path of the ball. It would be desirable to have a mobile arcade basketball system that combines the sun-protecting benefits of being inside, with the free space and fresh air available outside, along with the mobility to move the game anywhere without needing to pick up or carry the heavy game. It would be desirable to have a rapidly deployable, weather-resistant, self-contained arcade-style basketball experience that delivers the performance of professional amusement venues, but with the flexibility and mobility needed for modern event-based applications.

### SUMMARY OF THE INVENTION

This invention overcomes disadvantages of the prior art by providing a mobile arcade game system and method of using the mobile arcade game system. A mobile arcade game system can include a plurality of arcade games that are secured in place within a structurally rigid mobile platform. The system can be configured for road travel and rapid deployment at off-site locations, serving as a mobile, immersive basketball arcade. The system can include dual-purpose canopy doors, which can provide access while simultaneously acting as an overhead shelter to protect players from the sun and/or rain, thereby creating a semi-enclosed outdoor basketball environment allowing free movement and game play by the competitors, while also allowing quick set up and deployment by the user. The system may be designed to provide low set up time, high durability, and professional-grade play.

In an embodiment, a mobile arcade game system can include a mobile platform. The mobile platform can include at least one axle with at least two wheels connected at either end of the at least one axle, a foundation floor, four sidewalls, and a ceiling. The mobile platform can include at least one dual-purpose selectively openable wall panel on one sidewall, the dual-purpose selectively openable wall panel can hingedly close to seal a side of the mobile platform in a closed position, and the dual-purpose selectively openable wall panel can hingedly open to form a sun shade in an open position, and at least one opening, the at least one opening revealed by the dual-purpose selectively openable wall panel in the open position, and the at least one opening sealed by the dual-purpose selectively openable wall panel in the closed position. The mobile platform can include an upper floor, and a chamber defined by the foundation floor, the upper floor, and a portion of the sidewalls. The mobile arcade game system can include a plurality of arcade games, wherein the arcade games are secured to the upper floor, above the chamber. The at least two wheels can be located below the arcade games and below the upper floor. The at least two wheels can be located inside of the sidewalls. The at least one opening can extend from approximately six inches or less below the ceiling to approximately six inches or less above a ramp of the arcade games. The chamber can include at least one strut extending between the upper floor and the foundation floor, and the at least one strut at least partially extending from a first sidewall to a second sidewall, wherein the at least one strut at least partially supports the weight of the upper floor and the plurality of game machines while also providing structural rigidity to the chamber.

In an embodiment, a method of using a mobile arcade game system can include hitching the mobile arcade game system to a towing vehicle, the mobile arcade game system can include a mobile platform with at least one axle with at least two wheels connected at either end of the at least one axle, a foundation floor, four sidewalls, and a ceiling, at least one dual-purpose selectively openable wall panel within one sidewall, at least one opening, an upper floor, and a chamber defined by the foundation floor, the upper floor, and a portion of the sidewalls, and a plurality of arcade games, wherein the arcade games are secured to the upper floor, above the chamber. The method can include moving the mobile arcade game system from a first location to a second location, swinging the dual-purpose selectively openable wall panels upwards to form a sun shade in an open position while simultaneously revealing electronic arcade games behind an opening in the sidewall of the mobile arcade game system, turning on the plurality of arcade games, and providing an outdoor play area for players to play the electronic arcade game outdoors while also enjoying the protected environment under the sun shade. The method can include packing the system for transport by switching off the arcade games and discontinuing the power supply. The method can include sealing the opening in the sidewall by swinging the dual-purpose selectively openable wall panels downwards into a closed position. The method can include transporting the mobile arcade game system away from the second location.

A method of constructing a mobile arcade game system can include obtaining a trailer, with the trailer having at least one axle with at least two wheels connected at either end of the at least one axle, a foundation floor, four sidewalls, and a ceiling, at least one dual-purpose selectively openable wall panel within one sidewall, the dual-purpose selectively openable wall panel hingedly closing to seal a side of the mobile platform in a closed position, and the dual-purpose selectively openable wall panel hingedly opening to form a sun shade in an open position, and at least one opening, the at least one opening revealed by the dual-purpose selectively openable wall panel in the open position, and the at least one opening sealed by the dual-purpose selectively openable wall panel in the closed position. The method can include affixing one or more struts to the foundation floor, securing an upper floor to the mobile arcade game system to form a chamber, the upper floor positioned above the struts and above the at least two wheels, placing a plurality of arcade games on the upper floor, and positioning the plurality of arcade games at the at least one opening so that a game play area of the arcade games is exposed by the opening in the sidewall.

### BRIEF DESCRIPTION OF THE DRAWINGS

The invention description below refers to the accompanying drawings, of which:

FIG. 1 is a perspective view of a mobile arcade basketball system and with competitors playing arcade basketball, according to an illustrative embodiment;

FIG. 2A is a front view of the mobile arcade basketball system with the wall panels in the open, sun shade position, according to an illustrative embodiment;

FIG. 2B is a perspective view of the mobile arcade basketball system with the wall panels in the open, sun shade position, according to an illustrative embodiment;

FIG. 2C is a right-side view of the mobile arcade basketball system with the wall panels in the open, sun shade position, according to an illustrative embodiment;

FIG. 2D is a rear view of the mobile arcade basketball system with the wall panels in the open, sun shade position, according to an illustrative embodiment;

FIG. 2E is a left side view of the mobile arcade basketball system with the wall panels in the open, sun shade position, and showing an access panel, according to an illustrative embodiment.

FIG. 3A is a front view of the mobile arcade basketball system with the wall panels in the closed, sealed position, according to an illustrative embodiment;

FIG. 3B is a perspective view of the mobile arcade basketball system with the wall panels in the closed, sealed position, according to an illustrative embodiment;

FIG. 3C is a left side view of the mobile arcade basketball system with the wall panels in the closed, sealed position, according to an illustrative embodiment;

FIG. 3D is a rear view of the mobile arcade basketball system with the wall panels in the closed, sealed position, according to an illustrative embodiment;

FIG. 3E is a right-side view of the mobile arcade basketball system with the wall panels in the closed, sealed position, according to an illustrative embodiment;

FIG. 4 is a perspective view of the interior of a partially assembled mobile arcade basketball system without the game machines, showing the interior chamber, according to an illustrative embodiment;

FIG. 5 is a cross section of the mobile arcade basketball system, taken at cross section line 5-5 in FIG. 2C, showing the interior chamber, according to an illustrative embodiment;

FIG. 6 is a side view of a mobile arcade football system and with competitors playing arcade football, according to an illustrative embodiment;

FIG. 7A is a front view of the mobile arcade football system with the wall panels in the open, sun shade position, according to an illustrative embodiment;

FIG. 7B is a perspective view of the mobile arcade football system with the wall panels in the open, sun shade position, according to an illustrative embodiment;

FIG. 7C is a right-side view of the mobile arcade football system with the wall panels in the open, sun shade position, according to an illustrative embodiment;

FIG. 7D is a rear view of the mobile arcade football system with the wall panels in the open, sun shade position, according to an illustrative embodiment;

FIG. 7E is a left side view of the mobile arcade football system with the wall panels in the open, sun shade position, according to an illustrative embodiment;

FIG. 8 is a chart showing a method of using a mobile arcade game system, according to an illustrative embodiment;

FIG. 9 is a chart showing a method of playing at a mobile arcade basketball game system, according to an illustrative embodiment; and

FIG. 10 is a chart showing a method of construction of a mobile arcade basketball game system, according to an illustrative embodiment.

### DETAILED DESCRIPTION

The description herein includes a mobile arcade basketball trailer system and method of use. Although this invention is disclosed in the context of certain embodiments and examples, it should be understood by those skilled in the art that the present invention extends beyond the specifically disclosed embodiments and/or uses of the invention and obvious modifications and equivalents thereof. Thus, it is intended that the scope of the present invention herein disclosed should not be limited by the particular disclosed embodiments described herein.

Various embodiments are discussed hereinafter. It should be noted that the figures are described only to facilitate the description of the embodiments. They are not intended as an exhaustive description of the invention and do not limit the scope of the invention. Additionally, any particular embodiment need not have all the aspects or advantages described herein. Thus, in various embodiments, any of the features described herein from different embodiments may be combined. It should be clear that these are descriptions of implementations of the invention, and not descriptions of the invention, which is not limited to the detailed implementations described in this section. Further, the terms and phrases used herein are not intended to be limiting but rather to provide an understandable description of the invention. All illustrations of the drawings are for the purpose of describing selected versions of the present invention and are not intended to limit the scope of the present invention.

Some embodiments, illustrating its features, will now be discussed in detail. The words “having,” “containing,” and “including,” and other forms thereof, are intended to be equivalent in meaning and be open ended in that an item or items following any one of these words is not meant to be an exhaustive listing of such item or items, or meant to be limited to only the listed item or items. As used herein and in the appended claims, the singular forms “a,” “an,” and “the” include plural references unless the context clearly dictates otherwise.

References to “one embodiment,” “an embodiment,” “various embodiments,” “one example,” “an example,” “another example,” and so on, indicate that the embodiment(s) or example(s) so described may include a particular feature, structure, characteristic, property, element, or limitation, but that not every embodiment or example necessarily includes that particular feature, structure, characteristic, property, element or limitation.

As described herein, a mobile arcade system can be designed as a mobile arcade basketball system, however, it should be clear that the mobile arcade system can also include arcade football, or other arcade style games, and particularly arcade style games that simulate physical sports, including ball throwing or other activities that benefit from a significant amount of space around, in front of, and/or above the arcade game. In the interest of ease of description, the mobile arcade system is described herein as being a mobile arcade basketball system having arcade basketball games, however, it should be clear that the mobile arcade system described herein can accommodate various arcade games, including arcade basketball, arcade football, various throwing games, and others, and that various arcade games are specifically considered and are included within the scope of this description.

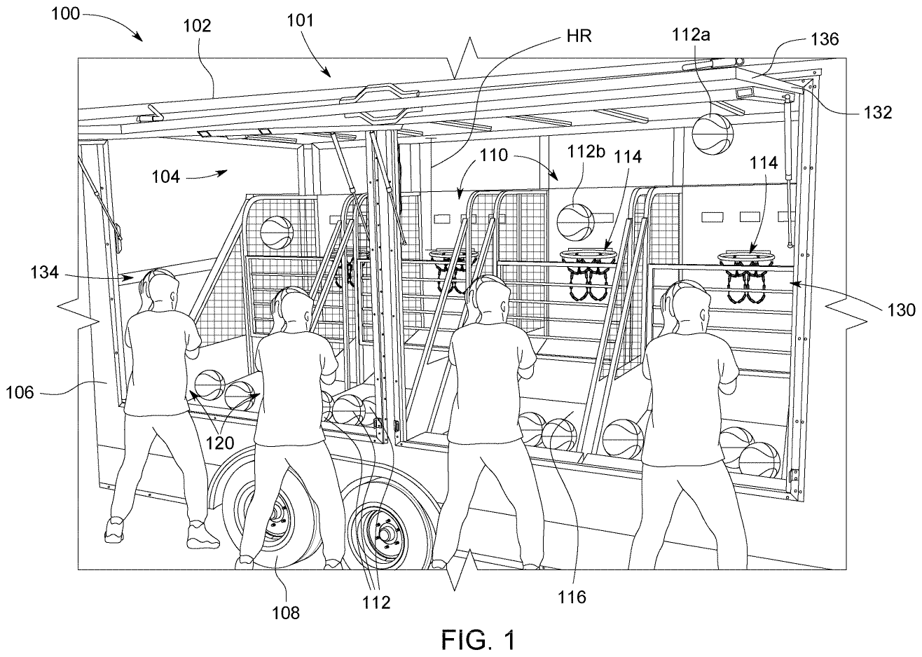

FIG. 1 is a perspective view of a mobile arcade basketball system, and showing players using the game, according to an illustrative embodiment. In various embodiments, the mobile arcade system can be a mobile arcade basketball system 100, and may be housed in a mobile platform such as a trailer 101, a bus, a van, or other mobile platforms that may be self-powered or towed behind another vehicle. In the interest of ease of description, the mobile arcade basketball system 100 herein is described as being housed within a mobile trailer for towing behind another vehicle, however, it should be clear that various other mobile platforms are specifically considered and are included within the scope of this description. As shown in FIG. 1, a mobile arcade basketball system 100 may include a trailer 101. The mobile arcade basketball system 100 may have one or more doors 130 along one side. The doors 130 can include selectively openable dual-purpose wall panels 132 and the wall panels 132 may be lifted on hinges to reveal an opening 134 in the sidewall 106 of the trailer 101.

Inside of the trailer 101, the mobile arcade basketball system 100 can have a plurality of arcade basketball game machines 110. In various embodiments, there may be four arcade basketball game machines, however, more than four or fewer than four are also possible. The arcade basketball game machines can be positioned in a side-by-side arrangement, so that players 120 can play head-to-head, in a competitive environment, with each player capable of monitoring their own score and the scores of other players at the same time. The opening 134 can be in the side of the trailer, along the longest dimension of the trailer, to allow many game machines 110 to be positioned side-by-side. The number of game machines that can be positioned side-by-side and played simultaneously, and thus the number of players who can compete simultaneously against each other, can vary by the length of the trailer, which in various embodiments may be as long as the legally allowable length of a trailer under local vehicle laws. Multiple dual-purpose selectively openable wall panels 132 can open to reveal multiple openings 134 along the sidewall 106 of the trailer 101.

Players can stand outside of the mobile arcade game system and can play indoor-style arcade games that have historically required being fixed in a fixed location, and play those games outdoors in the shade. Players 120 can throw balls 112 in an arced path upward and forward towards the goal 114, which can be a hoop. After balls 112 are thrown, they can land on a sloped ball return ramp 116. Ball return ramp 116 can slope gently towards the side of the mobile arcade basketball system 100, so that the balls can be picked up and re-thrown by the player. In various embodiments, the ball return ramp 116 can meet the sidewall 106 of the mobile arcade basketball system 100 slightly below the opening 134. The opening 134 can at least partially expose the balls 112 at the end of the ramp 116. In this way, the balls 112 may rest at the end of the ramp 116 and at the opening 134, and may be easily picked up through the opening by the player.

The ramp 116 can end at or near the opening 134, and the player can stand at the opening and grab the balls. The mobile arcade basketball system 100 can have wheels 108 that can be located under the ramp 116. The wheels can extend outward from the sidewall a small distance that can be less than the width of the wheel, or the wheels may not extend out from the sidewall of the trailer at all. The wheels may be entirely inside of the sidewalls. In this way, the wheels do not interfere with the player's ability to stand at the opening and grab balls through the opening at the bottom of the ramp. The arcade basketball game machines 110 may be positioned at least partially above the wheels 108, which are located at least partially inside of the sidewall 106, so that the wheels do not impact game play, and all shooting positions at each of the game machines 110 have the same playability, without interference from the wheels.

It should be clear that the balls must travel in a path that includes an apex that is well above the goal 114, so that the balls can be traveling at least partially downward as they reach the goal, thereby being pulled through the goal under the force of gravity. As shown in FIG. 1, ball 112a is traveling in an arced path that is above the arcade basketball game machine 100 so that the ball can fall through the goal 114. Ball 112b is falling in a path that is likely to pass through the goal 114. The mobile arcade basketball system 100 has a ceiling 102 to prevent sunlight from directly striking the eyes of the players, however the ceiling 102 is high enough to allow sufficient headspace 104 for the balls to arc through. In various embodiments, the headspace may have a vertical distance HR between the goal and the inside of the ceiling that may be between approximately 34 inches and approximately 52 inches. In various embodiments, the headspace may have a vertical distance HR between the goal and the inside of the ceiling that may be between approximately 36 inches and approximately 46 inches. In various embodiments, the headspace may have a vertical distance HR between the goal and the inside of the ceiling that may be approximately 40 inches. The trailer can be exceptionally tall to allow sufficient headspace above the basket, and with sufficiently large doors to allow access and playability.

A door 130 can have hinges at the top edge of the wall panel 132, where the wall panel hingedly meets the sidewall 106. In the down position, the wall panel can close the side of the mobile arcade basketball system, so that the games are encapsulated within the trailer. In the up position, the wall panel 132 can be hinged upwards to expose the opening 134. In the up position, the wall panels can form sun shades 136. In this way, the multi-functional wall panels 132 can function to seal the games inside when they are in the down position, and the multi-functional wall panels 132 can double as a sun shade 136 when they are in the up position. Sun shades 136 can block the sunlight over the players and provide shade, allowing players to play the game outdoors without the sunlight in their eyes.

The doors can be large panels that can swing upward to remove a large portion of the sidewall, revealing large openings in the side of the trailer. In various embodiments, the doors can have a door height DH in a range between approximately 67 inches and approximately 85 inches. In various embodiments, the doors can have a door height DH in a range between approximately 69 inches and approximately 79 inches. In various embodiments, the doors can have a door height that can be approximately 73 inches. Although this could result in structural weakness for the trailer system, these large doors provide multiple benefits. On one hand, the large doors provide significant sun shade area for players, ensuring the players can move freely around the play area during gameplay without accidentally stepping outside of the shade area and blinding themselves mid-throw. Additionally, the large doors allow the player to throw balls high above the player's head, in the headspace above the game, so that balls can fall into the basket in an arced path. The large doors and large sunshade area combine to allow a player to take a step back and throw the basketball in a high, arced path, in a manner that is a common basketball skill. By having the large opening and large sunshade, combined with the large headspace, the player can enjoy a more natural and enjoyable basketball experience.

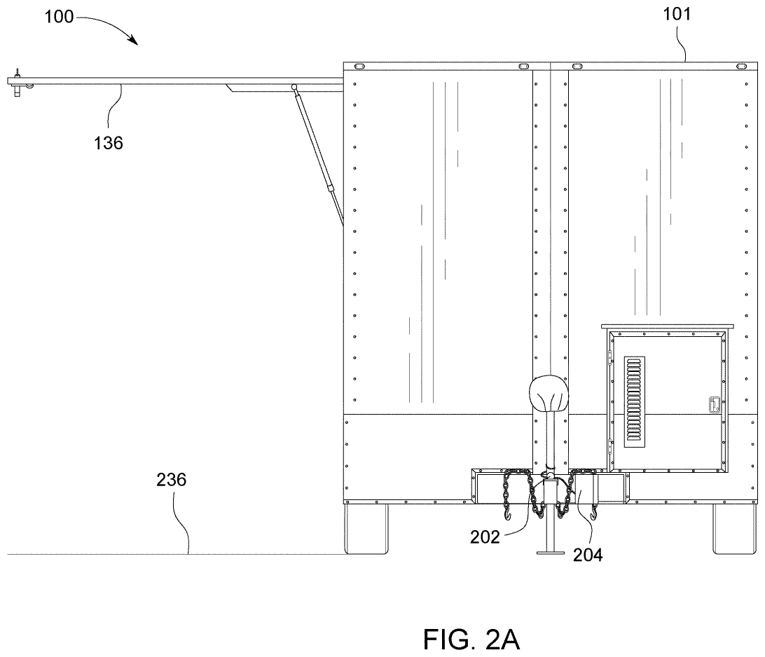

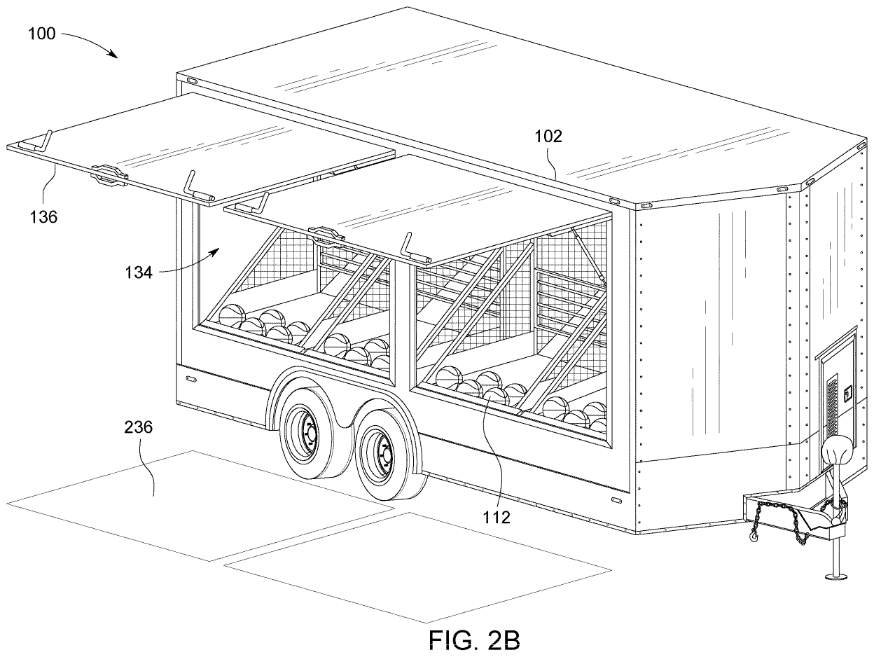

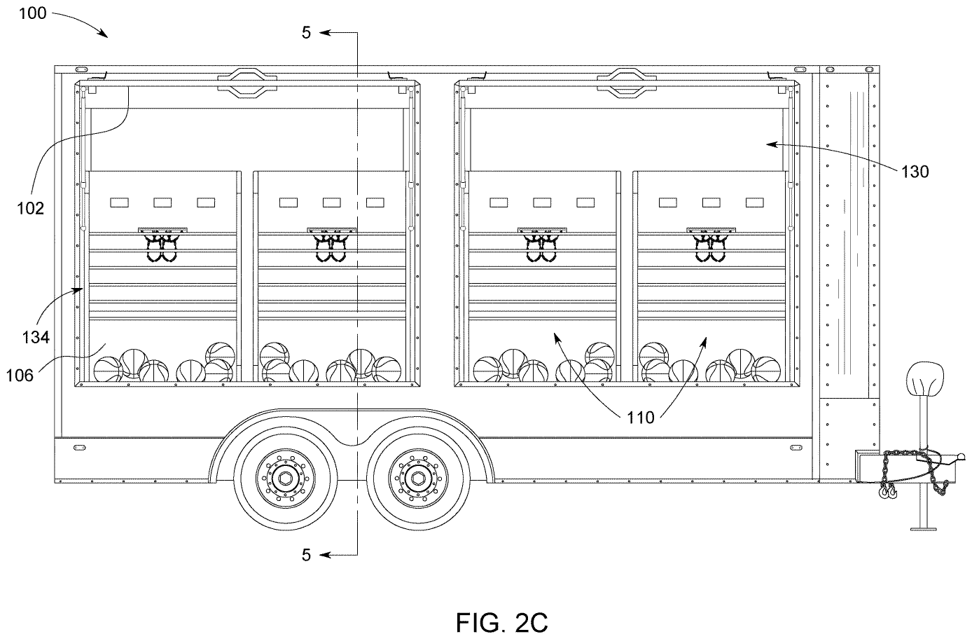

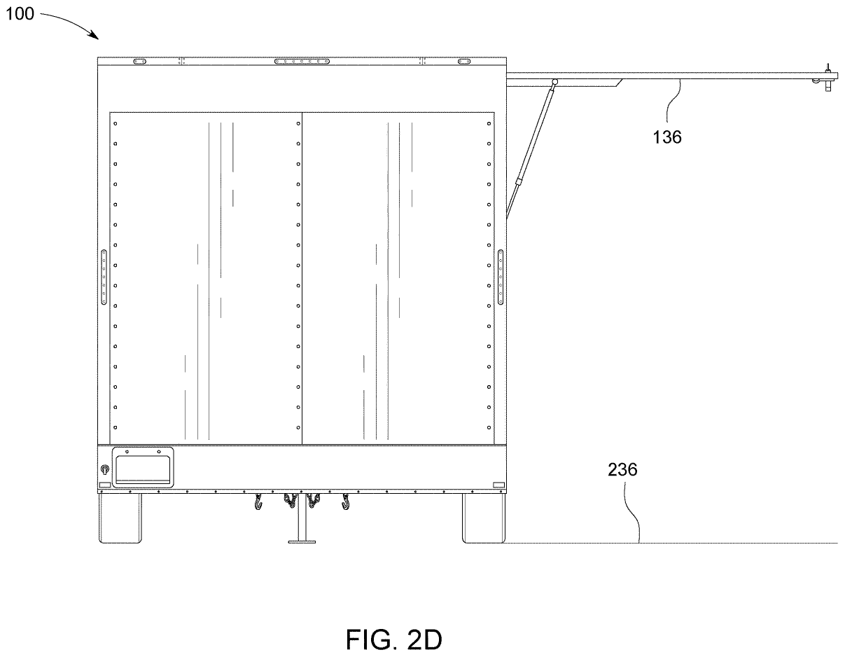

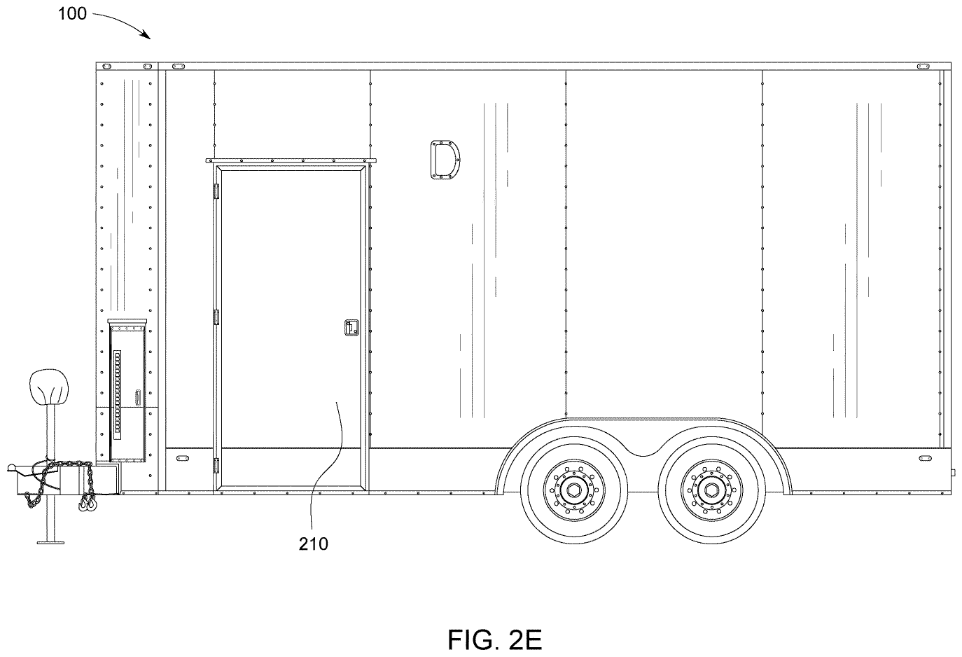

FIG. 2A is a front view of the mobile arcade basketball system with the wall panels in the open, sun shade position, according to an illustrative embodiment. The sun shades 136 may provide shade 236 so that the players can play the game outdoors in an area with ample space and fresh air, without the distraction of sunlight in their eyes. As shown, the mobile arcade basketball system 100 can include a trailer 101, and the trailer can be equipped with a hitch 202 and one or more leveling jacks 204. Leveling jacks 204 can be used to ensure the mobile arcade basketball system is level during set up, so that the game play is consistent regardless of location or terrain. A user can raise or lower the end of the trailer, sides of the trailer, and or corners of the trailer, as is known in the art, in order to provide a level trailer and consistent game play. In various embodiments, a mobile arcade basketball system can include a plurality of leveling jacks, including jacks that can be placed at sides and/or corners of the mobile arcade system.

FIG. 2B is a perspective view of the mobile arcade basketball system with the wall panels in the open, sun shade position, according to an illustrative embodiment. When the wall panels 132 are in the full open position, they form sunshades 136, and reveal openings 134. Openings 134 can be hinged near the ceiling 102 of the mobile arcade basketball system, so that most of the headspace above the games is exposed through the opening. Opening 134 can extend from near the ceiling 102 at the top of the opening, to slightly above the wheels 108 at the bottom of the opening. The wheels can be entirely or at least partially inside of the sidewall, so that the wheels do not extend outwards into the play space in front of the games, and the opening can end slightly above the wheels 108.

The dual-purpose wall panels 134 can have a door height DH that can be approximately 73 inches. In the open position, the dual-purpose wall panels can create a sunshade 136 that can be approximately 73 inches long. The extra length of the sunshades 136 can create a sufficiently large area of shade 236 that enables the users to move around freely under the shade while playing basketball without stepping out of the shade and being blinded by the sun. Although these long dual-purpose wall panels are able to create an extended area of shade, the extra-long size and cantilevered weight in the open position require the mobile arcade basketball system to have additional structural reinforcement, explained more fully below.

In various embodiments, the end of the ramp can be slightly lower than the opening. In various embodiments, the difference in height from the end of the ramp to the bottom of the opening can be less than the height of the ball 112, so that the balls at the end of the ramp may stick up and be at least partially exposed through the opening 134. In various embodiments, more than half of the height of the ball may be exposed through the opening. In various embodiments, the ball 112 can be approximately seven inches tall.

In various embodiments, one or more openings 134 can extend substantially from top to bottom of the play area, and can extend substantially from one side of the play area to the other side, so that the most of the sidewall 106 is open, thereby allowing maximum access for players playing the game and throwing the balls. FIG. 2C is a right-side view of the mobile arcade basketball system with the wall panels in the open, sun shade position, according to an illustrative embodiment. A game play area can be defined by the ceiling 102 at the top of the game play area, and the game play area can be defined by the ramp 116 along the bottom of the game play area. Most of the sidewall 106 along one side may be doors 130, so that most of the side of the trailer may be opened up as openings 134. The openings can expose substantially all of the game play area, from close to the ceiling to slightly above the ramp. In various embodiments, the opening can expose substantially all of the game play area, with the difference in height between the ramp and the bottom of the opening being less than the height of the ball. The openings 134 can extend from side to side so that they expose the entire side-to-side play area of the game machines 110.

FIG. 2D is a rear view of the mobile arcade basketball system with the wall panels in the open, sun shade position, according to an illustrative embodiment. Because of the large size of the openings and the wall panels, the wall panel are able to form a sunshade that creates a large area of shade 236. This large shaded area allows players to move back and forth, take steps towards the basket and step back again, etc., without leaving the shaded area or being blinded by the sun.

FIG. 2E is a left side view of the mobile arcade basketball system with the wall panels in the open, sun shade position, according to an illustrative embodiment. The mobile arcade basketball system 100 can have an access panel 210. Access panel 210 can be opened to grant a user access to the backs of the game machines, switch games on, and/or access to electrical controls, fuses, switches, generator, or other behind the scenes aspects of the games.

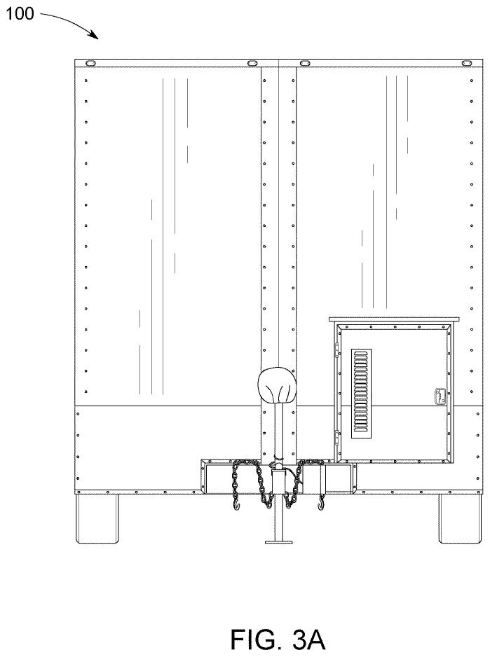

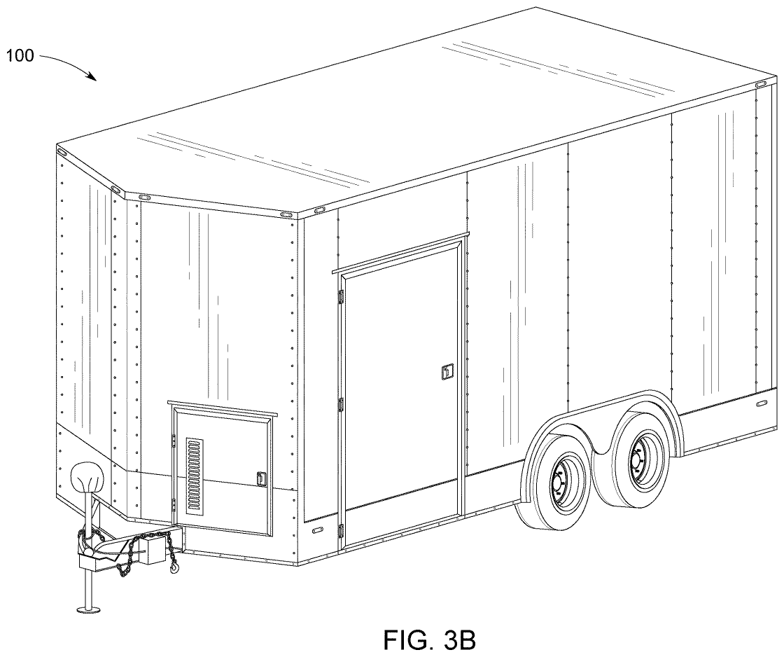

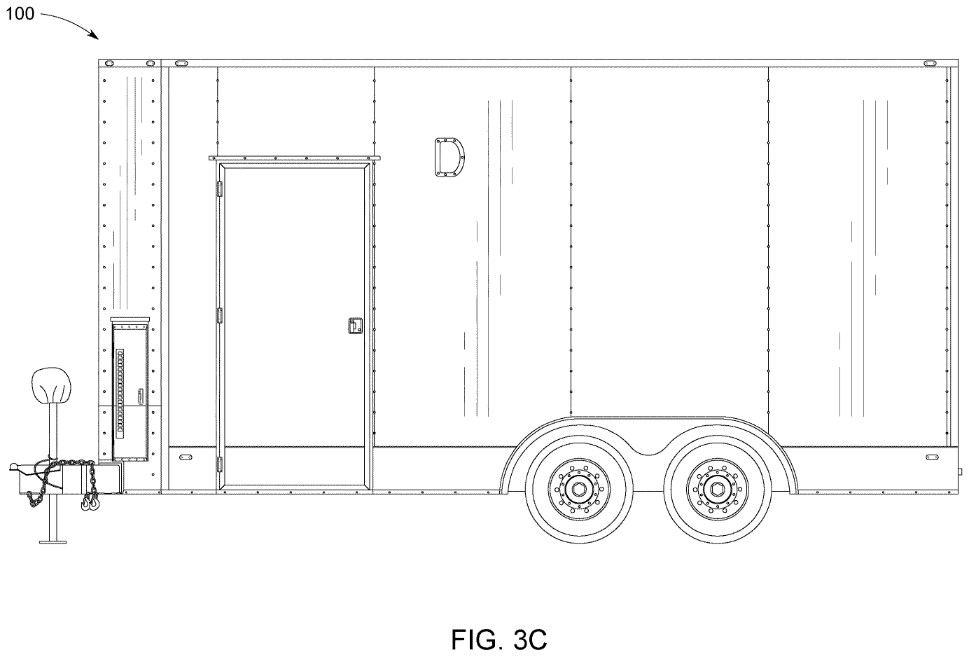

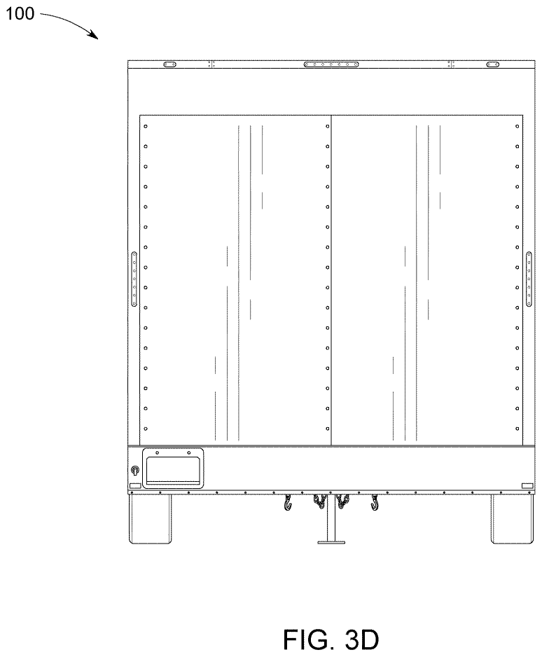

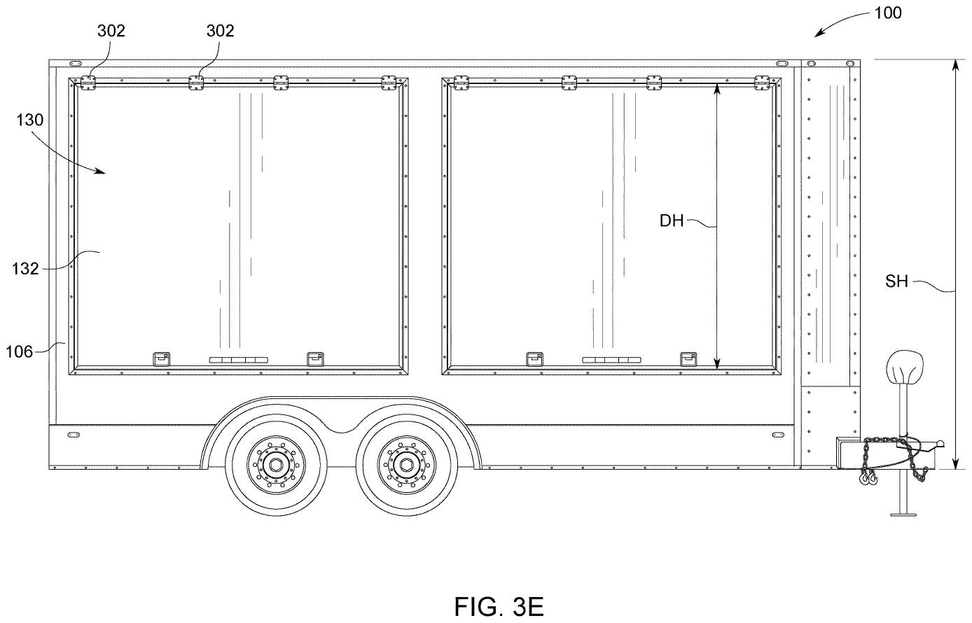

FIGS. 3A-3E are front view, perspective view, left side view, rear view, and right-side view, respectively, of the mobile arcade basketball system with the wall panels in the closed, sealed position, according to an illustrative embodiment. The dual-purpose wall panels 132 can be attached to the sidewall 106 with hinges 302. The wall panels 132 can be swung downwards on hinges 302 from the open position shown in FIGS. 2A-2D to the closed position shown FIGS. 3A-3E. in the closed position, the wall panels 132 are blocking the openings, and the doors 130 are sealed. With the wall panels in the closed position, the trailer can be entirely enclosed, and the games can be sealed inside of the mobile arcade basketball system where they are safe from weather, theft, vandalism, or other threat.

Turning to FIG. 3E, in various embodiments, the trailer can have a sidewall height SH that can be in a range between approximately 90 inches and approximately 108 inches. In various embodiments, the trailer can have a sidewall height SH that can be in a range between approximately 92 inches and approximately 102 inches. In various embodiments, a trailer can have a sidewall height SH that can be approximately 96 inches. This exceptionally tall sidewall is necessary to allow sufficient headspace above the goal so that balls can be thrown in a high arcing path that can fall into the goal naturally.

However, the exceptionally tall sidewalls combined with the exceptionally large doors can compound the problems with the stability and structural integrity of the trailer. The large doors remove a majority of the sidewall, which may cause a trailer to be structurally deficient. In various embodiments, the sidewall can have a sidewall height SH in a range between approximately 90 inches and approximately 108 inches, and the doors can have a door height DH in a range between approximately 67 inches and approximately 85 inches, which can result in approximately 74% to approximately 79% of the vertical span of the sidewall being removed to make openings in the sidewalls. Put another way, in various embodiments, the dual purpose selectively openable wall panel can have a vertical height in a range between approximately 74% and approximately 79% of the vertical height of the sidewall of the mobile basketball arcade system. In various embodiments, the sidewall can have a sidewall height SH in a range between approximately 92 inches and approximately 102 inches, and the doors can have a door height DH in a range between approximately 69 inches and approximately 79 inches, which can result in approximately 75% to approximately 77% of the vertical span of the sidewall being removed to make openings in the sidewalls. Put another way, in various embodiments, the dual purpose selectively openable wall panel can have a vertical height in a range between approximately 75% and approximately 79% of the vertical height of the sidewall of the mobile basketball arcade system In various embodiments, the sidewall can have a sidewall height SH of approximately 96 inches, and the doors can have a door height DH of approximately 73 inches, which can result in approximately 76% of the vertical span of the sidewall being removed to make openings in the sidewalls. Put another way, in various embodiments, the dual purpose selectively openable wall panel can have a vertical height that can be approximately 76% of the vertical height of the sidewall of the mobile basketball arcade system. The abnormally tall sidewalls to accommodate the headspace for the game can create structural weakness by themselves, but the problems can be compounded by the need for abnormally large doors to allow sufficient access and throwing area for the game. The large door height can mean that a significant portion of the sidewall is removed to make openings, thereby resulting in structural weakness for the trailer. The compounded effect of extra tall sidewalls with extra tall doors removing approximately 74% to 79% of the vertical sidewall can cause serious structural problems for a vehicle that must be road worthy. A double floor and inner support chamber system can help to restore structural integrity.

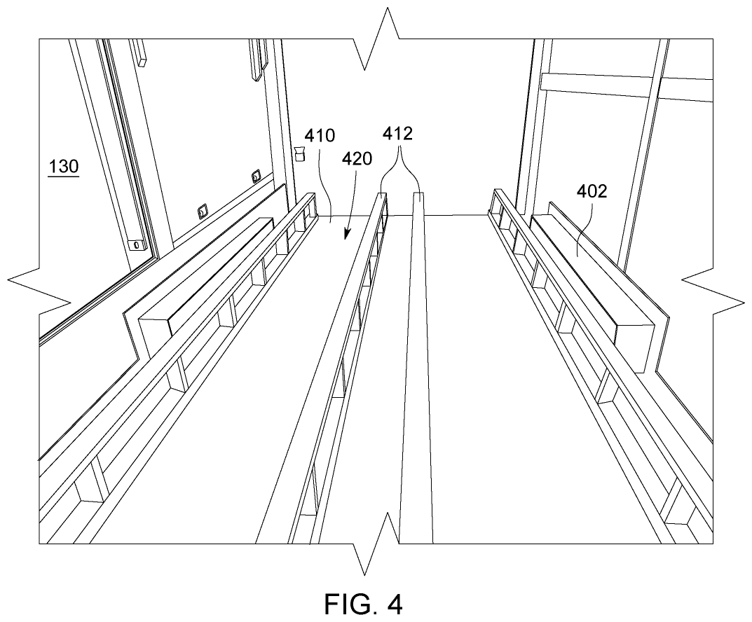

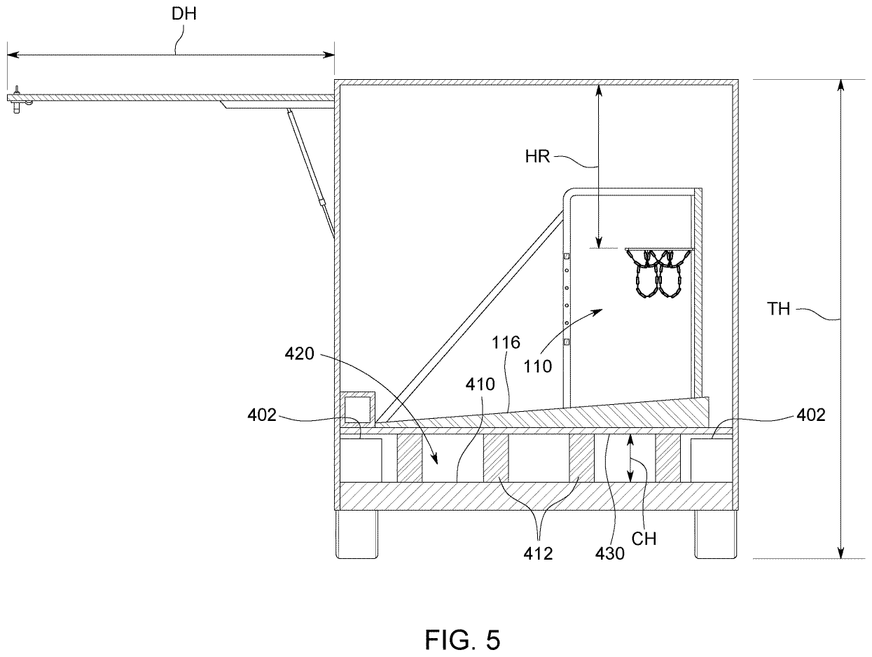

FIG. 4 is a perspective view of the interior of a partially assembled mobile arcade basketball system without the game machines, showing the interior chamber, according to an illustrative embodiment, and FIG. 5 is a cross section of the mobile arcade basketball system, taken at cross section line 5-5 in FIG. 2C, showing the interior chamber, according to an illustrative embodiment. Turning to FIGS. 4 and 5, in various embodiments, the trailer can have an overall trailer height TH from the ground to the ceiling that can be in a range between approximately 114 inches and approximately 132 inches. In various embodiments, the trailer can have an overall trailer height TH from the ground to the ceiling that can be in a range between approximately 116 inches and approximately 126 inches. In various embodiments, the trailer can have an overall trailer height TH from the ground to the ceiling that can be approximately 120 inches. This exceptionally tall trailer allows for sufficient headspace to the balls to fly in an arced path inside the trailer. This exceptionally tall trailer also allows for large doors that open to create large areas of shade while also providing large, high openings to the players to access the game and throw balls above their heads. However, the unusually tall trailer that has large vertical doors can face unusual structural concerns. In order to overcome the decreased structural rigidity that results from the unusually tall trailer that has large vertical doors which remove most of the sidewall when open, the trailer system can incorporate a double floor and chamber system to increase the overall structural rigidity of the trailer.

The mobile arcade basketball system can have a foundation floor 410 at the bottom of the mobile arcade basketball system, and a chamber 420 can be a space under the game machines that can be defined between the foundation floor 410 and an upper floor 430 under the bottoms of the arcade basketball game machines. The top of the chamber can be defined by the upper floor. In various embodiments, the upper floor can be secured to the sidewalls of the trailer. In various embodiments, the upper floor can be secured to various sidewalls, including left side, right side, and/or rear sides of the trailer. By securing the upper floor to the sidewalls, the upper floor can increase the structural strength of the trailer. Increasing the structural strength of the trailer allows the trailer to have above average height providing sufficient headroom for game play, while also allowing for massive openings in the sidewalls that might otherwise weaken the structure of the trailer.

One or more struts 412 may extend across the foundation floor 410 and may help to support the weight of the game machines. In various embodiments, one or more struts 412 may extend from side to side, and/or end to end, and in various embodiments can fill at least a portion of the area of the chamber 420. In various embodiments, the upper floor can be secured to the struts 412. In various embodiments, the upper floor can be secured to the struts 412 and/or to the sidewalls of the trailer, and the game machines can be secured to the upper floor. The chamber under the game machines can include the foundation floor, the struts, the lower portions of the side wall, and the upper floor. The foundation floor, the struts, the lower portions of the sidewall, and the upper floor of the chamber can be secured to each other to create a rigid cross-braced structure that resists torsion and further stiffens the structure of the trailer 101. That is to say, the foundation floor and the upper floor can be locked in a rigid structure in a way that gives torsional rigidity to the trailer. Having the upper floor positioned above, but not far from, the foundation floor can provide maximum rigidity while simultaneously avoiding interference with the game play. In various embodiments, the chamber can have a chamber height CH in a range between approximately 8 and approximately 12 inches. In various embodiments, the chamber can have a chamber height CH of approximately 10 inches. This additional structural rigidity allows the trailer to be taller than normal, with sufficient headspace for game play, while also allowing most of the right-side sidewall above the upper floor to be replaced by doors with openings that expose substantially all of the game play area, from close to the ceiling to slightly above the upper floor.

The chamber 420 may be adapted to provide various acoustic effects. In various embodiments, the chamber can provide acoustic amplification. The chamber can amplify the sound of the balls striking the ramp, thereby increasing the appeal of the arcade game system. In various embodiments, the chamber can have one or more broadcast openings that can be in communication between the inside of the chamber and the exterior ambient environment outside of the mobile basketball arcade system, and the one or more broadcast openings can help to broadcast the amplified sounds out of the chamber to the surrounding area. The chamber can form an acoustic resonance chamber, and the sounds of balls striking the goal, the ramp, and/or other parts of the arcade games can be released into the outside environment. These amplified game sounds can provide additional excitement to players who are competing against each other, and can draw additional players from some distance away who may be lured by the sounds of game play to come and play for themselves.

In various embodiments, the one or more broadcast openings can be selectively closable, so that the amplified sound can be muffled when necessary. In various embodiments, the chamber 420 can be filled with a noise-cancelling insulation material to dampen the sound of game play. Providing sound dampening material in the chamber can reduce the sound of game play so that the mobile arcade basketball system can be played anywhere, including residential areas.

In various embodiments, the wheel shrouds 402 of the trailer can be substantially within the chamber 420, and the upper floor 430 and game machines 110 can be above the wheel shrouds. The door 130 can open to reveal the game machines secured to the subfloor above the wheel shrouds. This arrangement with the wheels under the game machines allows equal game play for all players, without interference from the wheels.

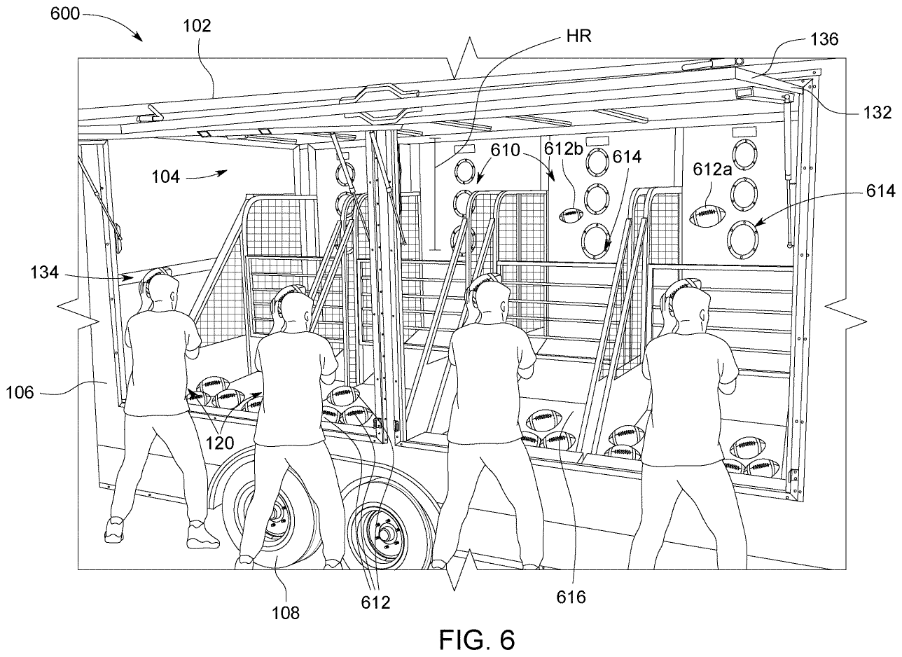

FIG. 6 is a side view of a mobile arcade football system and with competitors playing arcade football, according to an illustrative embodiment. In various embodiments, a mobile arcade system can be a mobile arcade football system 600. The mobile arcade football system 600 can include a trailer 101, and the system may have one or more doors 130 along one side. The doors 130 can include dual-purpose selectively openable wall panels 132 and the wall panels 132 may be lifted on hinges to reveal an opening 134 in the sidewall 106 of the trailer 101.

Inside of the trailer 101, the mobile arcade football system 600 can have a plurality of arcade football game machines 610. In various embodiments, there may be four arcade football game machines, however, more than four or fewer than four are also possible. The arcade football game machines can be positioned in a side-by-side arrangement, so that players 120 can play head-to-head, in a competitive environment, with each player capable of monitoring their own score and the scores of other players at the same time. The opening 134 can be in the side of the trailer, along the longest dimension of the trailer, to allow many game machines 110 to be positioned side-by-side. The number of game machines that can be positioned side-by-side and played simultaneously, and thus the number of players who can compete simultaneously against each other, can vary by the length of the trailer, which in various embodiments may be as long as the legally allowable length of a trailer under local vehicle laws. Multiple dual-purpose selectively openable wall panels 132 can open to reveal multiple openings 134 along the sidewall 106 of the trailer 101.

Players 120 can throw balls 612 towards the goals 614, which can be openings at the rear of the arcade football game. After balls 612 are thrown, they can land on a sloped ball return ramp 616. Ball return ramp 616 can slope gently towards the side of the mobile arcade football system 100, so that the balls can be picked up and re-thrown by the player. In various embodiments, the ball return ramp 616 can meet the sidewall 106 of the mobile arcade football system 100 slightly below the opening 134. The opening 134 can at least partially expose the balls 612 at the end of the ramp 616. In this way, the balls 612 may rest at the end of the ramp 616 and at the opening 134, and may be easily picked up through the opening by the player.

The ramp 616 can end at or near the opening 134, and the player can stand at the opening and grab the balls. The mobile arcade football system 600 can have wheels 108 that can be located under the ramp 616. The wheels can extend outward from the sidewall a small distance that can be less than the width of the wheel, or the wheels may not extend out from the sidewall of the trailer at all. The wheels may be entirely inside of the sidewalls. In this way, the wheels do not interfere with the player's ability to stand at the opening and grab balls through the opening at the bottom of the ramp. The arcade football game machines 610 may be positioned at least partially above the wheels 108, which are located at least partially inside of the sidewall 106, so that the wheels do not impact game play, and all throwing positions at each of the game machines 610 have the same playability, without interference from the wheels.

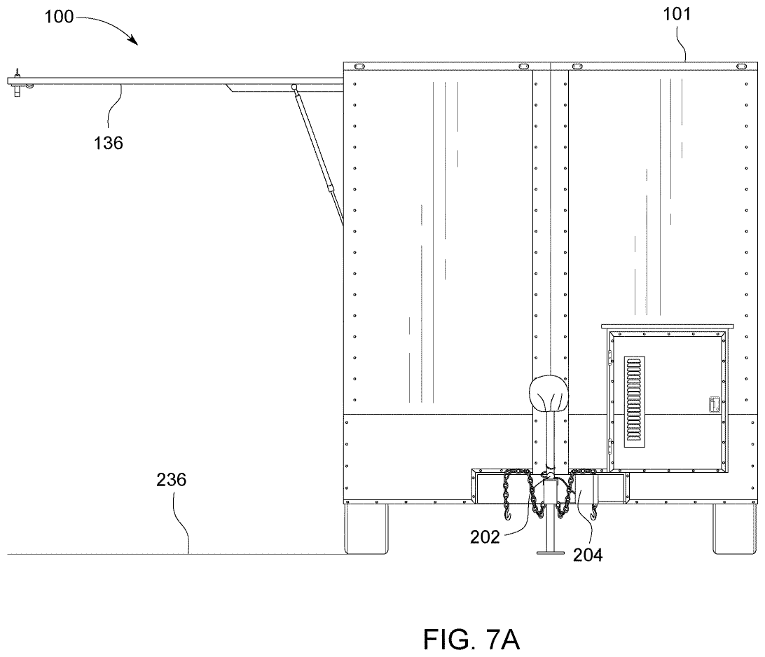

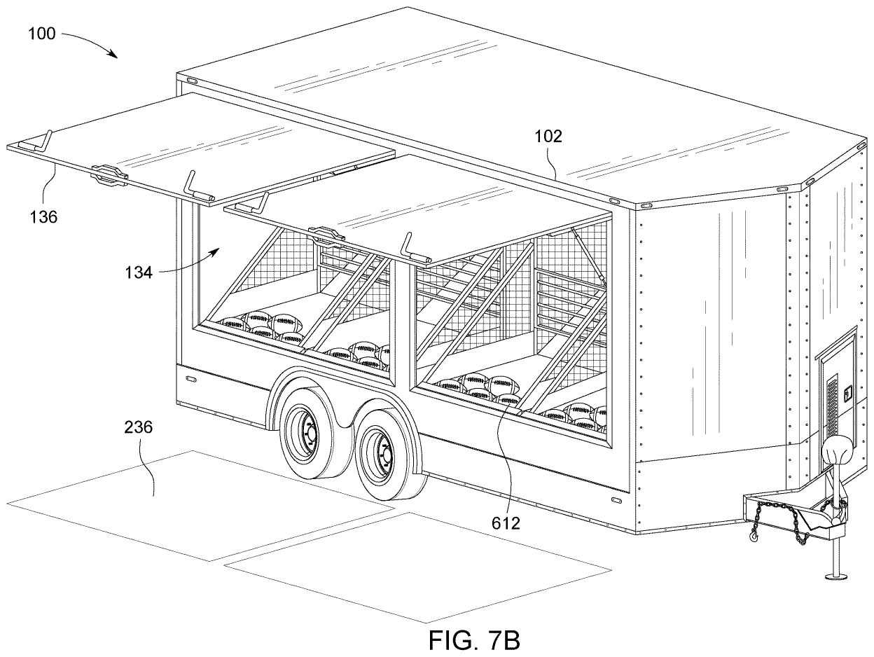

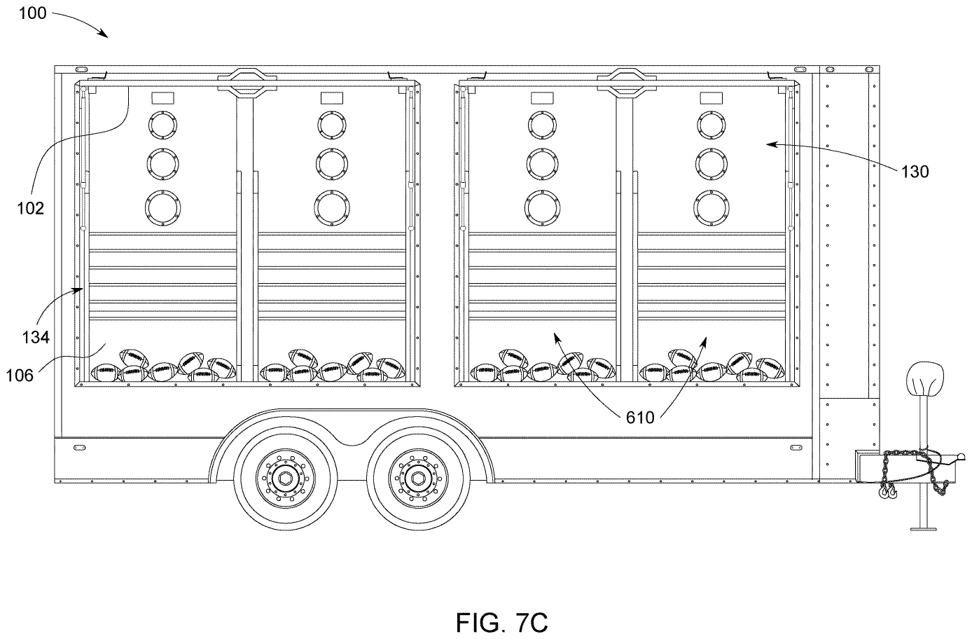

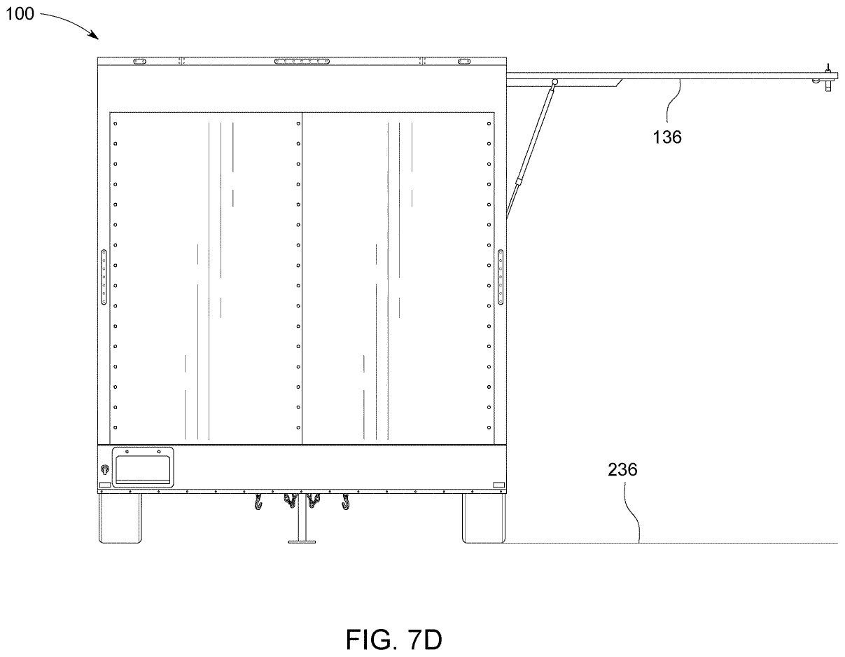

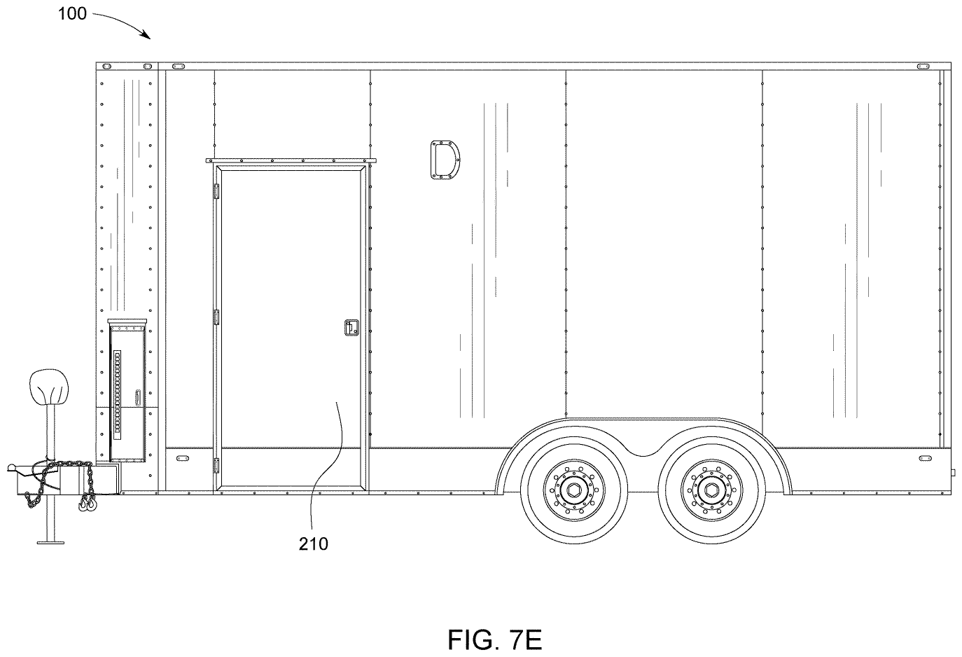

FIGS. 7A-7E are a front view, a perspective view, a right-side view, a rear view, and a left side view of the mobile arcade football system with the wall panels in the open, sun shade position, according to an illustrative embodiment. As shown in FIGS. 7A-7E, the design and the structural principles of the mobile arcade system may be the same for electronic mobile arcade basketball systems, electronic mobile arcade football systems, or other electronic mobile arcade game systems. The mobile arcade system described herein can be used with various arcade games, at least because the mobile arcade system may have wheels tucked under the arcade games to avoid interfering with game play, dual-purpose wall panels that can double as sun shades, a dual-purpose chamber defined by an upper floor and a foundation floor providing both structural and acoustic benefits, and/or other design features and structural principles that allow the mobile arcade system to function better than stationary arcade games or other previously known mobile games.

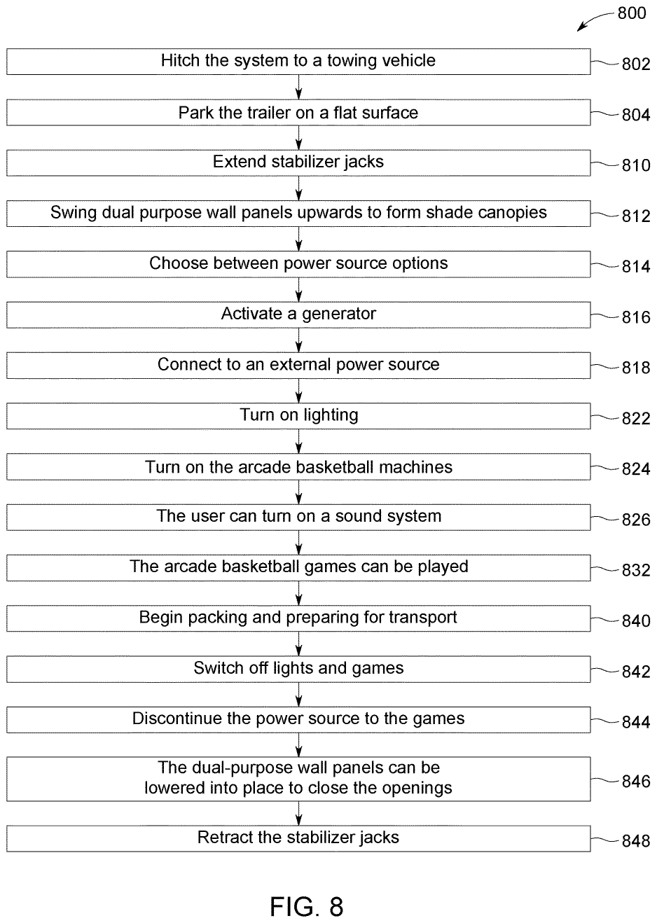

FIG. 8 is a chart showing a method 800 of using a mobile arcade game system, according to an illustrative embodiment. At box 802 the mobile arcade game system can be hitched to a towing vehicle at a first location and transported to a second location. At box 804, the trailer can be parked on a flat or approximately flat surface at the second location. At box 810, stabilizer jacks can be extended to level the trailer. The trailer can be leveled to ensure consistent, fair game play in any location, and at any game machine. At box 812, the dual-purpose wall panels can be opened and swung upwards, forming shade canopies that can define the playing area. At box 814, a user can choose between power source options to power the electronic arcade games. At box 816, the user can opt to activate a generator to provide power. At box 818, the user can opt to connect the mobile arcade game system to an external power source. At box 822, the user can turn on various lighting options, including overhead lights, colored LED lights, laser lighting, or other lighting options. At box 824, the user can turn on the arcade basketball machines, powered by the power source chosen at box 814. At box 826, the user can turn on a sound system, and can connect the sound system to a music source such as a mobile device, radio, or others.

At box 832, a user can play, and/or can invite other players to play, the arcade basketball games. The free-standing, all-in-one design can be deployed in under five minutes, and with no external structures, tents, or assembly. Players can stand under the dual-purpose wall panels and sunshades, which form a shaded, semi-protected playing zone directly in front of the trailer. Gameplay can be casually enjoyed, or can be organized into competitions or other tournaments, and the user can optionally manage the flow of games and competitors and/or can manage and maintain the game equipment.

At box 840, the user can begin packing and preparing the mobile arcade basketball game system for transport away from the second location. At box 842, the user can power off all games, lights, and sound systems. At box 844, the user can discontinue the power source to the games, either by turning off the generator or disconnecting from external power. At box 846, the dual-purpose wall panels can be lowered into place to close the openings, and can be latched into place to seal the mobile arcade basketball game system. At box 848, the stabilizer jacks can be retracted and the trailer can be hitched to the vehicle to leave the second location.

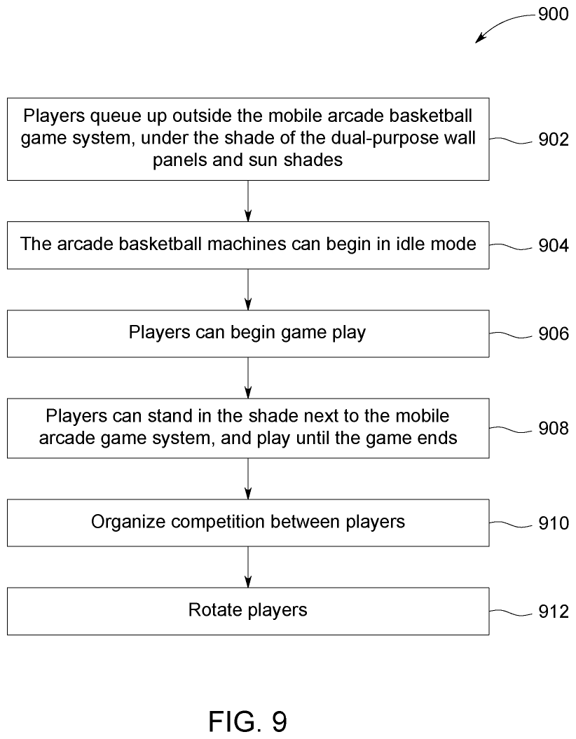

FIG. 9 is a chart showing a method of playing at a mobile arcade basketball game system, according to an illustrative embodiment. At box 902, players can queue up outside the mobile arcade basketball game system, under the shade of the dual-purpose wall panels and sun shades. At box 904, the arcade basketball machines can begin in idle mode. At box 906, in various embodiments, players can initiate game play by pressing a start button or by simply beginning to throw a ball. At box 908, players can stand outdoors, in the shade next to the mobile arcade game system, and continue to throw balls through the goal until a predetermined period of time has elapsed and the game ends. At box 910, players may be organized to compete against each other with competitive scoring between players. At box 912, players may rotate after the game ends at the end of the predetermined period of time, so that a large number of people call all play one after the next.

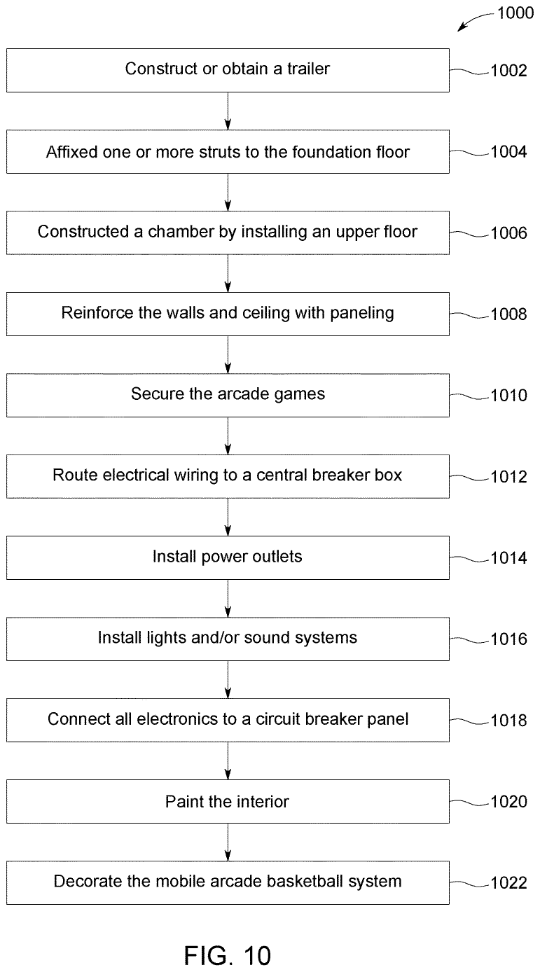

FIG. 10 is a chart showing a method of construction of a mobile arcade basketball game system, according to an illustrative embodiment. At box 1002, a trailer can be constructed or obtained with a sufficiently high headspace under the ceiling. The trailer can be built to be sufficiently strong and rigid to maintain shape and integrity while also allowing massive doors to swing upwards exposing openings encompassing nearly the entire side of the trailer. At box 1004, one or more struts can be affixed to the foundation floor of the trailer. At box 1006 a chamber can be constructed by installing an upper floor to create additional stability and strength in the mobile arcade basketball game system. In various embodiments, the upper floor can be installed above the wheel shrouds and/or struts. In various embodiments, the upper floor can be affixed to one or more struts and/or to one or more sidewalls to increase the structural integrity of the system. At box 1008, the walls and ceiling can be reinforced with paneling for strength, aesthetics, and/or sound insulation. At box 1010, the arcade games can be secured within the system. The arcade games can be bolted to the upper floor and/or can be bolted or braced to the interior walls. At box 1012, electrical wiring can be routed from each unit to a central breaker box. At box 1014, power outlets can be installed within the mobile arcade basketball game system. At box 1016, the lights and/or sound systems can be installed. At box 1018, all electronics can be connected to a circuit breaker panel that can have shore power and/or generator inputs. At box 1020, the interior can be painted black for visual consistency and to ensure professional grade game play regardless of location or lighting conditions. At box 1022, the mobile arcade basketball system can optionally be wrapped in vinyl graphics, and or various signage, lighting effects, or branding decals can be applied to the mobile arcade basketball game system.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. Also, as used herein, various directional and orientational terms (and grammatical variations thereof) such as “vertical”, “horizontal”, “up”, “down”, “bottom”, “top”, “side”, “front”, “rear”, “left”, “right”, “forward”, “rearward”, and the like, are used only as relative conventions and not as absolute orientations with respect to a fixed coordinate system, such as the acting direction of gravity. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances (e.g. 5%) of the system. Note also, as used herein the terms “process” and/or “processor” should be taken broadly to include a variety of electronic hardware and/or software based functions and components. Moreover, a depicted process or processor can be combined with other processes and/or processors or divided into various sub-processes or processors. Such sub-processes and/or sub-processors can be variously combined according to embodiments herein. Likewise, it is expressly contemplated that any function, process and/or processor herein can be implemented using electronic hardware, software consisting of a non-transitory computer-readable medium of program instructions, or a combination of hardware and software. Accordingly, this description is meant to be taken only by way of example, and not to otherwise limit the scope of this invention.

What is claimed is:

1. A mobile arcade game system comprising:
a mobile platform, the mobile platform comprising:
at least one axle with at least two wheels connected at either end of the at least one axle;
a foundation floor, four sidewalls, and a ceiling;
at least one dual-purpose selectively openable wall panel on one sidewall, the dual-purpose selectively openable wall panel hingedly closing to seal a side of the mobile platform in a closed position, and the dual-purpose selectively openable wall panel hingedly opening to form a sun shade in an open position;
at least one opening, the at least one opening revealed by the dual-purpose selectively openable wall panel in the open position, and the at least one opening sealed by the dual-purpose selectively openable wall panel in the closed position,
an upper floor; and
a chamber defined by the foundation floor, the upper floor, and a portion of the sidewalls; and
a plurality of arcade games, wherein the arcade games are secured to the upper floor, above the chamber.

2. The mobile arcade game system of claim 1, wherein the at least two wheels are located below the arcade games and below the upper floor.

3. The mobile arcade game system of claim 2, wherein the at least two wheels are located inside of the sidewalls.

4. The mobile arcade game system of claim 1, wherein the at least one opening extends from approximately six inches or less below the ceiling to approximately six inches or less above a ramp of the arcade games.

5. The mobile arcade game system of claim 1, the chamber further comprising at least one strut extending between the upper floor and the foundation floor, and the at least one strut at least partially extending from a first sidewall to a second sidewall, wherein the at least one strut at least partially supports the weight of the upper floor and the plurality of game machines while also providing structural rigidity to the chamber.

6. A method of using a mobile arcade game system comprising:
hitching the mobile arcade game system to a towing vehicle, the mobile arcade game system comprising a mobile platform with at least one axle with at least two wheels connected at either end of the at least one axle, a foundation floor, four sidewalls, and a ceiling, at least one dual-purpose selectively openable wall panel within one sidewall, at least one opening, an upper floor, and a chamber defined by the foundation floor, the upper floor, and a portion of the sidewalls, and a plurality of arcade games, wherein the arcade games are secured to the upper floor, above the chamber;
moving the mobile arcade game system from a first location to a second location;
swinging the dual-purpose selectively openable wall panels upwards to form a sun shade in an open position while simultaneously revealing electronic arcade games behind an opening in the sidewall of the mobile arcade game system;
turning on the plurality of arcade games; and
providing an outdoor play area for players to play the electronic arcade game outdoors while also enjoying the protected environment under the sun shade.

7. The method of using the mobile arcade game system of claim 6, further comprising packing the system for transport by switching off the arcade games and discontinuing the power supply.

8. The method of using the mobile arcade game system of claim 7, further comprising sealing the opening in the sidewall by swinging the dual-purpose selectively openable wall panels downwards into a closed position.

9. The method of using the mobile arcade game system of claim 8, further comprising transporting the mobile arcade game system away from the second location.

10. A method of constructing a mobile arcade game system comprising:
obtaining a trailer, the trailer comprising at least one axle with at least two wheels connected at either end of the at least one axle, a foundation floor, four sidewalls, and a ceiling, at least one dual-purpose selectively openable wall panel within one sidewall, the dual-purpose selectively openable wall panel hingedly closing to seal a side of the mobile platform in a closed position, and the dual-purpose selectively openable wall panel hingedly opening to form a sun shade in an open position, and at least one opening, the at least one opening revealed by the dual-purpose selectively openable wall panel in the open position, and the at least one opening sealed by the dual-purpose selectively openable wall panel in the closed position;
affixing one or more struts to the foundation floor;
securing an upper floor to the mobile arcade game system to form a chamber, the upper floor positioned above the struts and above the at least two wheels;
placing a plurality of arcade games on the upper floor; and
positioning the plurality of arcade games at the at least one opening so that a game play area of the arcade games is exposed by the opening in the sidewall.
